(19) United States
(12) Patent Application Publication
(10) Pub. No.: US 2015/0344330 A1
(43) Pub. Date: Dec. 3, 2015

(54) Compact, Self Contained Reverse Osmosis Water Supply System

(71) Applicants: Douglas Kraig Schambough, Carencro, LA (US); Douglas Kirk Schambough, Carencro, LA (US); Jason Michael Badeaux, Gueydan, LA (US)

(72) Inventors: Douglas Kraig Schambough, Carencro, LA (US); Douglas Kirk Schambough, Carencro, LA (US); Jason Michael Badeaux, Gueydan, LA (US)

(21) Appl. No.: 14/728,251

(22) Filed: Jun. 2, 2015

Related U.S. Application Data
(60) Provisional application No. 62/006,936, filed on Jun. 3, 2014.

(51) Int. Cl. C02F 1/44; C02F 1/68

(52) U.S. Cl. CPC C02F 1/441; C02F 1/68

(57) ABSTRACT

A compact, reverse osmosis water desalinization and purification system positions the reverse osmosis components, a holding tank, and a pressure tank, which provides desalinated and purified water to the end user, compactly on a single frame and skid. A chlorinator and post filter may be provided to further treat the water.

### CROSS REFERENCE TO RELATED APPLICATIONS

This non-provisional United States patent application claims priority to U.S. provisional patent application Ser. No. 62/006,936, filed 3 Jun. 2014, for all purposes. The disclosure of that provisional patent application is incorporated herein, to the extent not inconsistent with this non-provisional patent application.

### BACKGROUND

### Field of the Invention

This invention relates to apparatus used in the purification, especially desalinization, of water.

A supply of fresh water is required for many industrial purposes. By way of example only, fresh water is needed on offshore facilities used in the oil and gas industry, for example offshore production platforms and drilling rigs, for many purposes. Fresh water is needed for human consumption, washing, bathing, etc., but is also needed for a number of uses in connection with the operation of the facility, for example makeup and/or additions to drilling fluids, washdown water, etc. Suffice to say that an adequate supply of fresh water is an ever present need on offshore facilities.

Traditionally, fresh water had to be brought to offshore facilities in large tanks in the holds of vessels. Once the vessel was at the offshore location, the fresh water was pumped from the tank in the vessel to the offshore facility. The time, expense, and logistical difficulties associated with this procedure are well known in the industry. As a result, a need has long existed to generate fresh water from the readily available water surrounding the facility, which in offshore environments is sea water (salt water), but in inland lakes and the like might be brackish or even fresh water, but which is not of a sufficient purity for use on the facility, particularly for human consumption.

Particularly addressing the desalinization of salt water, a number of types of “water makers” have long existed. As is known in the relevant art field, such devices have employed a number of principles, e.g. evaporation. One type of desalinization system which has been in use is a reverse osmosis or “RO” system, which typically comprises several different components as described below. Generally, a reverse osmosis process forces salt water through a porous membrane which permits water to flow through, but prevents salt from flowing through. Reverse osmosis units generally are capable of satisfactory water production rates.

However, known reverse osmosis system designs have certain limitations for use in offshore environments, in which space is at a premium on offshore facilities such as production platforms and drilling rigs. In particular, for larger capacity RO systems, for example capable of producing 250-500 barrels per day (BPD, measured in typical oilfield barrels of 42 gallons/barrel), prior art designs comprised three main components, each typically on its own skid, and with exemplary “footprint” dimensions shown:

(1) the reverse osmosis water desalinization unit or skid (skid #1), typically including the reserve osmosis membranes in their housings, an initial cartridge type filter upstream of the reverse osmosis membranes (pre-filter), along with instrumentation, controls, pumps, etc. as known in the art, a typical RO skid measuring 3 feet×5½ feet;

(2) a holding tank skid (skid #2), comprising one or more holding tanks which receive clean water from the RO unit (skid #1) and serve as a reservoir from which the “pressure set” (described below) is supplied; a typical holding tank skid measuring 10 feet×12 feet; and

(3) a “pressure set” skid (skid #3), which comprises one or more pressure tanks which receive water from the holding tank, hold the water under pressure in the tanks, and thereby provide a pressurized source to flow water to the various locations on the facility where needed, the pressure set having tanks, motors, pumps, and controls as known in the relevant art; a typical pressure set skid measuring 3 feet×5 feet.

It is readily understood that the overall system (RO skid+holding tank skid+pressure set skid) occupies a significant area or footprint in a setting in which space is at a premium.

It is further readily understood that an incentive exists to reduce the footprint of a reverse osmosis water supply system, while maintaining desired capacity.

### SUMMARY OF THE INVENTION

The Compact, Self Contained Reverse Osmosis Water Supply System embodying the principles of the present invention comprises a reverse osmosis water desalinization unit, a holding tank and a pressure set, all mounted on one self contained skid. The single skid arrangement greatly decreases piping, hoses, electric power cords, etc. required in multi-skid systems, and results in a much decreased footprint while retaining water making capacity.

The system of the present invention preferably comprises several other non-exclusive components which increase the efficiency of the system:
an in-line chlorination unit adds chlorine to the water produced from the RO unit, preferably prior to the water going into the holding tank;
automatic controls, which permit the RO unit to produce water and fill the holding tank, then shut the RO unit off until the water level within the holding tank has dropped by some predetermined amount;
a cartridge type water filter (post-filter) through which water flows from the pressure set, before flowing to the end use point, thus providing another level of filtration before use of the water; and
a control system which monitors various operating indicators for the system, and provides an indication of the reason(s) for system shutdowns (e.g. low/high oil level in pumps; a low feed pressure; high differential pressure across cartridge type filters; high Total Dissolved Solids (TDS) in produced water).

In addition, the reverse osmosis unit of the present invention comprises pumps, controls, etc. as known in the art for operation of such units.

### BRIEF DESCRIPTION OF THE DRAWINGS

FIG. 1 is a bird's eye or top view of the system embodying the principles of the present invention, illustrating primary components of the system and their general relationship on the frame/skid.

FIG. 2 is a front perspective view of the system.

FIG. 3 is a front view of the system.

FIG. 4 is a side view of the system.

### DESCRIPTION OF THE PRESENTLY PREFERRED EMBODIMENT(S)

While various configurations of reverse osmosis systems can embody the principles of the present invention, with reference to the drawings some of the presently preferred embodiments can be described.

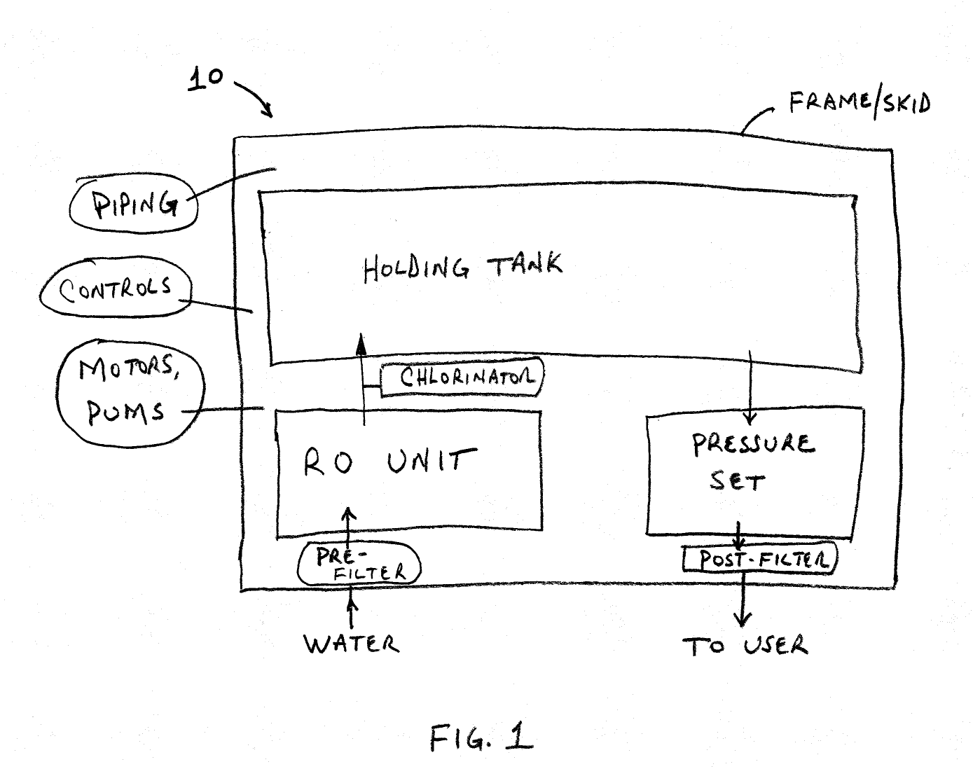

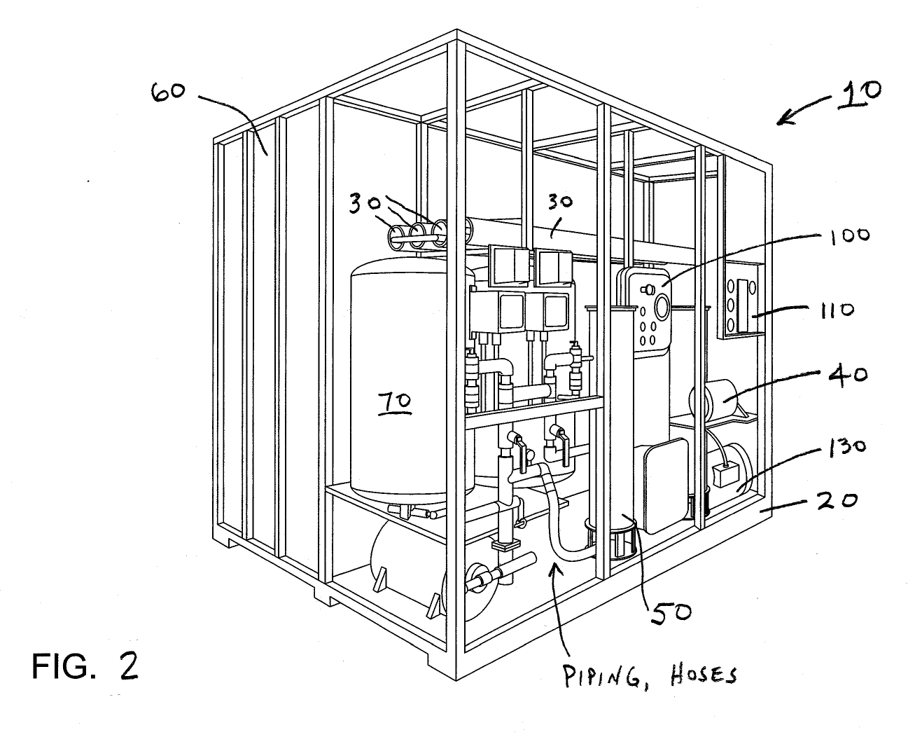

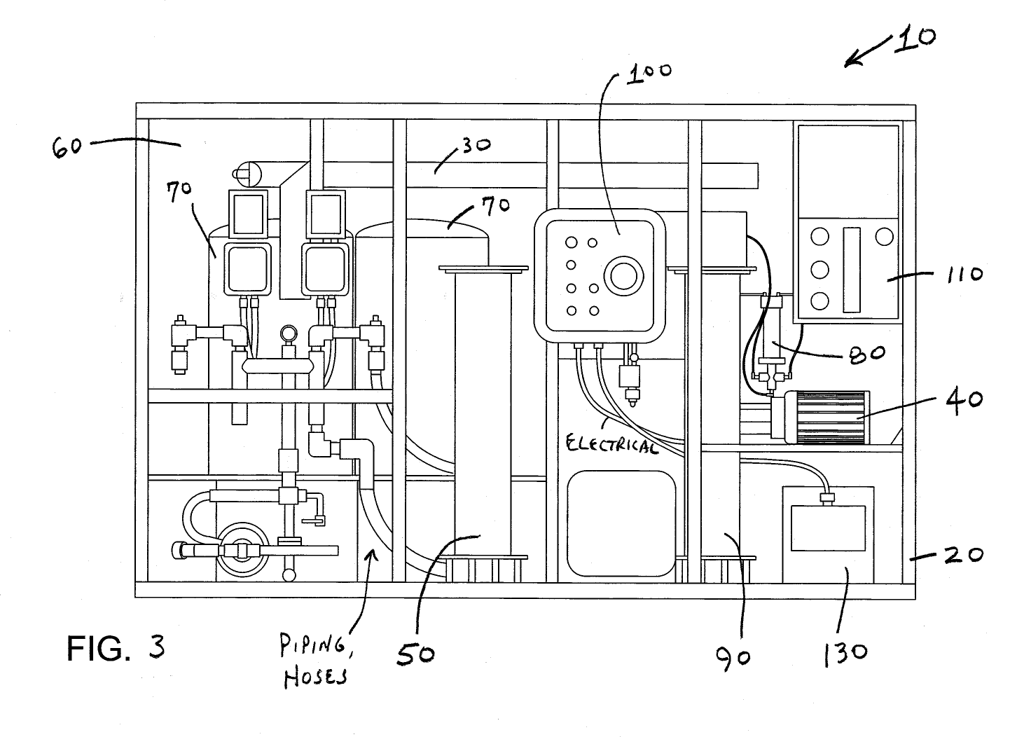

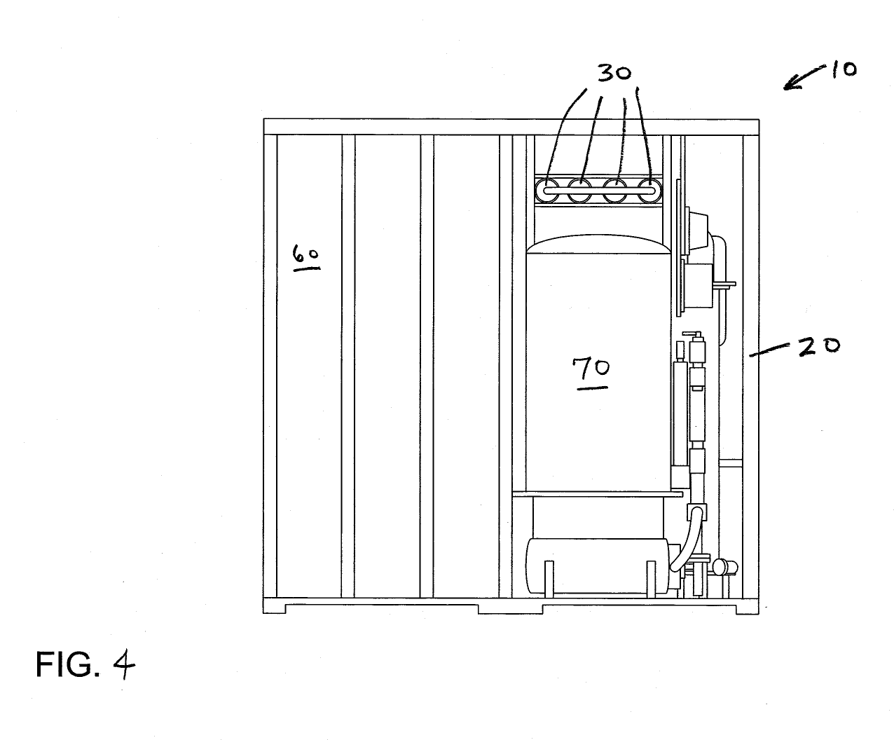

FIG. 1 is a bird's eye or top view of the system, in simplified form illustrating the primary elements of the present invention positioned on a frame/skid. Reference is also made to FIGS. 2-4, which show further detail of the various components of the system and illustrate an exemplary embodiment of same. While the three main components of the overall system are shown in FIG. 1 as separate or discrete components, in practice, as can be understood with reference to FIGS. 2-4, the parts of the overall system are positioned on the skid to achieve optimum operational efficiency and space savings and are therefore not necessarily physically separated.

RO water supply system 10 comprises a frame/skid 20 on which the various elements are mounted, providing for a compact, self contained system with a reduced number of connections between components, etc. Water (which may be salt water or other water source needing processing) is provided to the unit by means known in the art, and flows through a pre-filter 50, which is preferably a cartridge type filter, to remove solids and other particulate impurities. The water then flows through the reverse osmosis water desalinization unit, comprising reverse osmosis membrane assemblies contained within reverse osmosis membrane housings 30. One or more pumps are provided, as known in the art, to provide the water flow. While four horizontally-disposed membrane housings 30 are shown, a greater or lesser number may be used, depending upon desired capacity. Through the reverse osmosis process, as is known in the art, the water is desalinated. The water production capacity of the unit can be as needed, with typical capacities being 100, 250, or 500 BPD.

A chlorinator unit 80 provides chlorination to the desalinated water from the reverse osmosis unit, prior to the water entering holding tank 60. While various chlorinator units are commercially available and suitable for use, one suitable type uses chlorine tablets and is substantially automatic in operation.

Holding tank 60 receives desalinated, chlorinated water and serves as a reservoir for interim storage. Controls are provided which sense the water level in holding tank 60, and control operation of the reverse osmosis components (pumps, etc.) to maintain a desired water level within holding tank 60 but not overflow it. Holding tank may be made of any desired capacity, with an exemplary capacity being 55 barrels.

From holding tank 60, water flows to one or more pressure tanks 70, in which treated water is stored under pressure. This enables water flow to the desired locations on the facility which need water, under influence of the pressure in the tanks. While two pressure tanks 70 are shown, it is understood that a greater or lesser number could be used.

After leaving the pressure tanks 70, the water flows through a post filter 90, which is preferably a cartridge type filter. From post filter 90, the water flows to its end use point(s) on the facility. One or more pumps 40, preferably driven by electric motors 130, are positioned within frame/skid 20 to pump water throughout the system, including but not limited to pumping water at relatively high pressure through reverse osmosis membrane housings 30, as is known in the art. An electric panel 100 provides a site for electrical switches, connectors, etc. A control panel 110 contains various controls to monitor and control system operations. By way of example, the control system monitors various operating indicators for the system, and provides an indication of the reason(s) for system shutdowns (e.g. low/high oil level in pumps; a low feed pressure; high differential pressure across cartridge type filters; high Total Dissolved Solids (TDS) in produced water). Appropriate controls also permit the RO unit to produce water and fill the holding tank, then shut the RO unit off until the water level within the holding tank has dropped by some predetermined amount.

Exemplary piping, electrical conduits and the like are readily visible in the figures and understood by those having skill in the relevant art.

It is understood that certain of the system components are omitted from the drawings for clarity, such components not being essential to an understanding of the present invention.

Positioning all of the system components on a single frame/skid results in a compact, easier to transport RO water system. Typical dimensions for the system, as depicted in the drawings, are 10′6″ in length, 7′6″ in width, and 9′ in height. Larger or smaller systems may be possible depending upon particular settings.

The RO water system may be moved by a fork lift, or by a crane or similar apparatus with slings attached to the frame/skid by appropriate lift points, etc.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof. For example, the RO water supply system can be made in different output capacities to suit particular needs; overall dimensions can be modified to accommodate particular settings on offshore facilities and the like; the arrangement and positioning of the various components on the frame/skid can be varied as needed

Therefore, the scope of the invention is to be determined not by the illustrative examples set forth above, but by the appended claims and their legal equivalents.

We claim:

1. A compact water supply system, comprising:
a reverse osmosis water desalinization unit, comprising one or more reverse osmosis membrane assemblies through which water is forced to desalinate same;
a holding tank fluidly coupled to said reverse osmosis water desalinization unit, so as to receive desalinated water from said unit;
a pressure tank fluidly coupled to said holding tank, so as to receive water from said holding tank and hold said water at a pressure sufficient to move said water from said pressure tank to an end use point for said water;
a pump fluidly coupled to said water supply system, said pump driven by an electric motor;
a control panel and an electrical panel connected to said water supply system, to control water levels within and water flow through said system, wherein water production from said reverse osmosis unit is controlled to maintain a desired level in said holding tank; and
wherein said reverse osmosis water desalinization unit, said holding tank, and said pressure tank are disposed on a single frame/skid, forming a compact system, whereby said compact system is adapted to be moved by a forklift or crane.

2. The system of claim 1, further comprising a pre-filter fluidly coupled to and upstream of said reverse osmosis water desalinization unit.

3. The system of claim 2, further comprising a chlorinator unit which provides chlorination to water discharged from said reverse osmosis unit, before said water flows to said holding tank.

4. The system of claim 3, further comprising a cartridge type post filter downstream of said pressure set, through which water flows after leaving said pressure tank.

5. A combined reverse osmosis water desalinization unit, holding tank, and pressure tank assembly, comprising:
a skid and frame assembly adapted to be moved by a forklift or crane;
a reverse osmosis water desalinization unit mounted on said skid and frame assembly, comprising one or more reverse osmosis membrane assemblies through which water is forced to desalinate same, and a cartridge-type pre-filter to filter water before flowing through said reverse osmosis membrane assemblies;
a holding tank mounted on said skid and frame assembly and fluidly coupled to said reverse osmosis water desalinization unit, so as to receive desalinated water from said unit;
a chlorinator mounted on said skid and frame assembly upstream of said holding tank and operatively connected to water flow to said holding tank, for chlorination of said water flow;
a pressure tank mounted on said skid and frame assembly and fluidly coupled to said holding tank, so as to receive water from said holding tank and hold said water at a pressure sufficient to move said water from said pressure tank to an end use point for said water, and a cartridge type post filter downstream of said pressure tank through which said water flows;
a pump mounted on said skid and frame assembly and fluidly coupled to said water supply system, said pump driven by an electric motor;
a control panel and an electrical panel mounted on said skid and frame assembly and operatively connected to said water supply system, to control water levels within and water flow through said system, wherein water production from said reverse osmosis unit is controlled to maintain a desired level in said holding tank.
